(19) United States
(12) Patent Application Publication
(10) Pub. No.: US 2008/0005473 A1
(43) Pub. Date: Jan. 3, 2008

(54) COMPILER ASSISTED RE-CONFIGURABLE SOFTWARE IMPLEMENTED CACHE

(76) Inventors: Tong Chen, Yorktown Heights, NY (US); John Kevin Patrick O'Brien, South Salem, NY (US); Kathryn M. O'Brien, South Salem, NY (US); Byoungro So, Santa Clara, CA (US); Zehra N. Sura, Yorktown Heights, NY (US); Tao Zhang, Duluth, GA (US)

Correspondence Address: IBM CORP (YA);C/O YEE & ASSOCIATES PC, P.O. BOX 802333, DALLAS, TX, 75380, US

(21) Appl. No.: 11/427,790

(22) Filed: Jun. 30, 2006

(51) Int. Cl. G06F 12/00

(52) U.S. Cl. 711/118

(57) ABSTRACT

A computer implemented method, data processing system, and computer usable program code are provided for configuring a cache. A compiler performs an analysis of software code to identify cacheable information in the software code that will be accessed in the cache at runtime. The properties of the cacheable information are analyzed to form a data reference analysis. Using the data reference analysis, a cache configuration is determined for caching the cacheable information during execution of the software code. Modified lookup code is inserted in the software code based on the cache configuration used to configure the cache.

### BACKGROUND

1. Field of the Invention

The present application relates generally to software implemented cache. More specifically, the present application relates to a compiler assisted re-configurable software implemented cache.

2. Description of the Related Art

In computer systems, a cache is a place to store something temporarily. Files that are automatically requested by looking at a Web page are stored on a hard disk in a cache subdirectory under the directory for a browser. When a return is made to a page that has been recently viewed, the browser can get the page from the cache rather than the original server, saving time and the network the burden of some additional traffic. The size of the cache can vary, depending on the particular browser.

Computers include caches at several levels of operation, including cache memory and a disk cache. Caching can also be implemented for Internet content by distributing it to multiple servers that are periodically refreshed. Some types of existing cache are:
International, national, regional, organizational and other “macro” caches to which highly popular information can be distributed and periodically updated and from which most users would obtain information.
Local server caches, for example, corporate local area network (LAN) servers or access provider servers that cache frequently accessed files. This is similar to the previous idea, except that the decision of what data to cache may be entirely local.
Web browser's cache, which contains the most recent Web files that have been downloaded and which is physically located on a hard disk and possibly some of the following caches at any moment in time.
A disk cache, either a reserved area of random access memory (RAM) or a special hard disk cache, where a copy of the most recently accessed data and adjacent data is stored for fast access.
RAM itself may be viewed as a cache for data that is initially loaded in from the hard disk or other I/O storage systems.
Level 2 (L2) cache memory is on a separate chip from the microprocessor but faster to access than regular RAM.
Level 1 (L1) cache memory is on the same chip as the microprocessor.

Typically, L1 and L2 cache memories are architectured such that hardware automatically manages the transfer of data to and from main memory, and ensures that coherence is maintained between multiple copies of data that exist due to caching. However, a system may be designed to include on-chip local memory space that is not a hardware-managed cache, but is available for applications to configure and use as desired. In this case, software must orchestrate all memory transfers to and from this local memory space, and it can direct some part of this memory space to be used as a cache. Cache that is implemented using software is commonly called “software implemented cache.” In a system that supports a software implemented cache, a trade-off exists between the size of the cache and using storage for other purposes.

### SUMMARY

The different aspects of the illustrative embodiments provide a computer implemented method, data processing system, and computer usable program code for configuring a cache. The illustrative embodiments perform an analysis of software code to identify cacheable information in the software code that will be accessed in the cache at runtime. The illustrative embodiments analyze properties of the cacheable information to form a data reference analysis. The illustrative embodiments use the data reference analysis to determine a cache configuration for caching the cacheable information during execution of the software code. The illustrative embodiments insert modified lookup code in the software code based on the cache configuration used to configure the cache.

### BRIEF DESCRIPTION OF THE DRAWINGS

The novel features believed characteristic of the illustrative embodiments are set forth in the appended claims. The illustrative embodiments, however, as well as a preferred mode of use, further objectives and advantages thereof, will best be understood by reference to the following detailed description of an illustrative embodiment when read in conjunction with the accompanying drawings, wherein:

FIG. 1 depicts an exemplary diagram of a cell broadband engine architecture-compliant processor in which aspects of the illustrative embodiments may be implemented in accordance with an illustrative embodiment;

FIG. 2 depicts the exemplary operation of a compiler that may be used to compile data used by an application in accordance with an illustrative embodiment;

FIG. 3 depicts an exemplary functional block diagram of the components in which the illustrative embodiments may be implemented;

FIG. 4 depicts an exemplary flowchart of the operations performed by an optimizing compiler in accordance with an illustrative embodiment;

FIG. 5 depicts exemplary cache configuration in accordance with an illustrative embodiment; and

FIG. 6 illustrates the use of a configurable software implemented cache within a data processing system in accordance with an illustrative embodiment.

### DETAILED DESCRIPTION

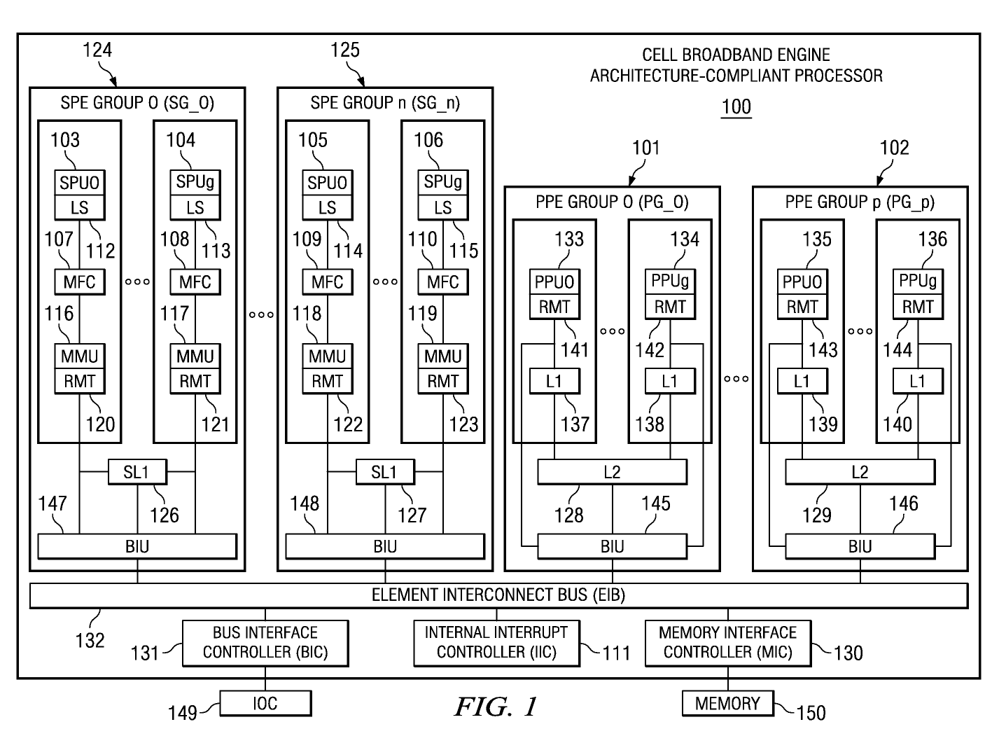

The illustrative embodiments provide for a compiler assisted re-configurable software implemented cache. With reference now to the figures and in particular with reference to FIG. 1, an exemplary diagram of a cell broadband engine architecture-compliant processor is shown in which aspects of the illustrative embodiments may be implemented in accordance with an illustrative embodiment. Cell broadband engine architecture-compliant processor 100 may consist of a single chip, a multi-chip module (or modules), or multiple single-chip modules on a motherboard or other second-level package, depending on the technology used and the cost/performance characteristics of the intended design point directed toward distributed processing targeted for media-rich applications such as game consoles, desktop systems, and servers.

Logically, cell broadband engine architecture 100 defines four separate types of functional components: Power PC® processor element (PPE) 101 or 102, synergistic processor unit (SPU) 103, 104, 105, or 106, memory flow controller (MFC) 107, 108, 109, or 110, and the internal interrupt controller (IIC) 111. The computational units in cell broadband engine architecture-compliant processor 100 are Power PC® processor elements 101 and 102 and synergistic processor units 103, 104, 105, and 106. Each synergistic processor unit 103, 104, 105, and 106 must have dedicated local storage 112, 113, 114, or 115, a dedicated memory flow controller 107, 108, 109, or 110 with its associated memory management unit (MMU) 116, 117, 118, or 119, and replacement management table (RMT) 120, 121, 122, or 123, respectively. The combination of these components is referred to as synergistic processor unit element (SPE) group 124 or 125.

Cell broadband engine architecture-compliant processor 100 depicts synergistic processor element groups 124 and 125 that share a single SL1 cache 126 and 127, respectively. An SL1 cache is a first-level cache for direct memory access transfers between local storage and main storage. Power PC® processor element groups 101 and 102 share single second-level (L2) caches 128 and 129, respectively. While caches are shown for the synergistic processor element groups 124 and 125 and Power PC® processor element groups 101 and 102, they are considered optional in the cell broadband engine architecture. Also included in FIG. 1 are two controllers typically found in a processor: memory interface controller (MIC) 130 and bus interface controller (BIC) 131. Memory interface controller 130 provides access to memory 150 for cell broadband engine architecture-compliant processor 100. Bus interface controller 131 provides an input/output interface to input/output controller (IOC) 149 for cell broadband engine architecture-compliant processor 100. Connecting the various units within the processor is element interconnect bus (EIB) 132. Since the requirements for the memory interface controller 130, bus interface controller 131, and element interconnect bus 132 vary widely between implementations, the definition for these units are beyond the scope of the cell broadband engine architecture.

Cell broadband engine architecture-compliant processor 100 may include multiple groups of Power PC® processor elements (PPE groups), such as Power PC® processor element group 101 or 102, and multiple groups of synergistic processor elements (SPE groups), such as synergistic processor element group 124 or 125. Hardware resources may be shared between units within a group. However, synergistic processor element groups 124 and 125 and Power PC® processor element groups 101 and 102 must appear to software as independent elements.

Each synergistic processor unit 103, 104, 105, and 106 in synergistic processor element groups 124 and 125 has its own local storage area 112, 113, 114, or 115 and dedicated memory flow controller 107, 108, 109, or 110 that includes an associated memory management unit 116, 117, 118, or 119, which can hold and process memory-protection and access-permission information.

Cell broadband engine architecture-compliant processor 100 includes one or more Power PC® processor element group 101 or 102. Power PC® processor element groups 101 and 102 consist of 64-bit Power PC® processor units (PPUs) 133, 134, 135, and 136 with associated L1 caches 137, 138, 139, and 140, respectively. Cell broadband engine architecture-compliant processor 100 system must include a vector multimedia extension unit (not shown) in the Power PC® processor element groups 101 and 102. Power PC® processor element groups 101 and 102 also contain replacement management table (RMT) 141, 142, 143, and 144 and bus interface unit (BIU) 145 and 146, respectively. Bus interface units 145 and 146 connect Power PC® processor element groups 101 or 102 to the element interconnect bus 132. Bus interface units 147 and 148 connect replacement management tables 120, 121, 122, and 123 to element interconnect bus 132.

Power PC® processor element groups 101 and 102 are general-purpose processing units, which can access system management resources, such as the memory-protection tables, for example. Hardware resources defined in the cell broadband engine architecture are mapped explicitly to the real address space as seen by Power PC® processor element groups 101 and 102. Therefore, any Power PC® processor element groups 101 and 102 may address any of these resources directly by using an appropriate effective address value. A primary function of Power PC® processor element groups 101 and 102 is the management and allocation of tasks for the synergistic processor element groups 124 and 125 in a system.

Cell broadband engine architecture-compliant processor 100 includes one or more synergistic processor units 103, 104, 105, or 106. Synergistic processor units 103, 104, 105, and 106 are less complex computational units than Power PC® processor element groups 101 and 102, in that they do not perform any system management functions. Synergistic processor units 103, 104, 105, and 106 have a single instruction multiple data (SIMD) capability and typically process data and initiate any required data transfers, subject to access properties set up by Power PC® processor element groups 101 and 102, in order to perform their allocated tasks.

The purpose of synergistic processor units 103, 104, 105, and 106 is to enable applications that require a higher computational unit density and may effectively use the provided instruction set. A significant number of synergistic processor units 103, 104, 105, and 106 in a system, managed by Power PC® processor element group 101 or 102, allow for cost-effective processing over a wide range of applications.

Memory flow controllers 107, 108, 109, and 110 are essentially the data transfer engines. Memory flow controllers 107, 108, 109, and 110 provide the primary method for data transfer, protection, and synchronization between main storage and the local storage. Memory flow controllers 107, 108, 109, and 110 commands describe the transfer to be performed. A principal architectural objective of memory flow controllers 107, 108, 109, and 110 is to perform these data transfer operations in as fast and as fair a manner as possible, thereby maximizing the overall throughput of cell broadband engine architecture-compliant processor 100.

Commands that transfer data are referred to as memory flow controller direct memory access commands. These commands are converted into direct memory access transfers between the local storage domain and main storage domain. Each of memory flow controllers 107, 108, 109, and 110 may typically support multiple direct memory access transfers at the same time and may maintain and process multiple memory flow controller commands.

In order to accomplish this, memory flow controllers 107, 108, 109, and 110 maintain and process queues of memory flow controller commands. Each memory flow controllers 107, 108, 109, and 110 provide one queue for the associated synergistic processor unit 103, 104, 105, or 106, memory flow controller synergistic processor unit command queue, and one queue for other processors and devices, memory flow controller proxy command queue. Logically, a set of memory flow controller queues is always associated with each synergistic processor unit 103, 104, 105, or 106 in cell broadband engine architecture-compliant processor 100, but some implementations of the architecture may share a single physical memory flow controller between multiple synergistic processor units. In such cases, all the memory flow controller facilities must appear to software as independent for each synergistic processor unit 103, 104, 105, or 106.

Each memory flow controller direct memory access data transfer command request involves both a local storage address (LSA) and an effective address (EA). The local storage address can directly address only the local storage area of its associated synergistic processor unit 103, 104, 105, or 106.

The effective address has a more general application, in that it can reference main storage, including all the synergistic processor unit local storage areas, if they are aliased into the real address space.

Memory flow controllers 107, 108, 109, and 110 present two types of interfaces: one to the synergistic processor units 103, 104, 105, and 106 and another to all other processors and devices in a processing group.
Synergistic processor unit channel: The synergistic processor units 103, 104, 105, and 106 use a channel interface to control memory flow controllers 107, 108, 109, and 110. In this case, code running on synergistic processor units 103, 104, 105, and 106 can only access the memory flow controller synergistic processor unit command queue for that synergistic processor unit 103, 104, 105, or 106.
Memory-Mapped Register: Other processors and devices control memory flow controllers 107, 108, 109, and 110 by using memory-mapped registers. It is possible for any processor and device in the system to control memory flow controllers 107, 108, 109, or 110 and to issue memory flow controller proxy command requests on behalf of synergistic processor unit 103, 104, 105, or 106.

Memory flow controllers 107, 108, 109, and 110 also support bandwidth reservation and data synchronization features.

Internal interrupt controller 111 manages the priority of the interrupts presented to Power PC® processor element groups 101 and 102. The main purpose of internal interrupt controller 111 is to allow interrupts from the other components in the processor to be handled without using the main system interrupt controller. Internal interrupt controller 111 is really a second level controller. Internal interrupt controller 111 is intended to handle all interrupts internal to a cell broadband engine architecture-compliant processor 100 or within a multiprocessor system of cell broadband engine architecture-compliant processor 100. The system interrupt controller will typically handle all interrupts external to cell broadband engine architecture-compliant processor 100.

In cell broadband engine architecture-compliant system, software must first check internal interrupt controller 111 to determine if the interrupt was sourced from an external system interrupt controller. Internal interrupt controller 111 is not intended to replace the main system interrupt controller for handling interrupts from all I/O devices.

The described illustrative embodiments provide a compiler optimized software implemented configurable cache that minimizes cache overhead for data that is accessed together. The optimizing compiler may dynamically re-configure the cache specific to different phases of a single execution and tailored to the requirements of that phase. The components of a software implemented cache that may be re-configured include total cache size, cache line size, number of lines, associativity, replacement policy, and a method used to determine where in the cache a particular data item should be placed when it is brought in. The optimizing compiler may classify application data based on its access properties, such as how often and how far apart the data is re-used, whether the data is being read, written, or both read and written, and whether the data is being shared across multiple threads of computation. This classification of data will result in the formation of one or more data classes. The optimizing compiler may use multiple co-existent cache configurations, one for each data class.

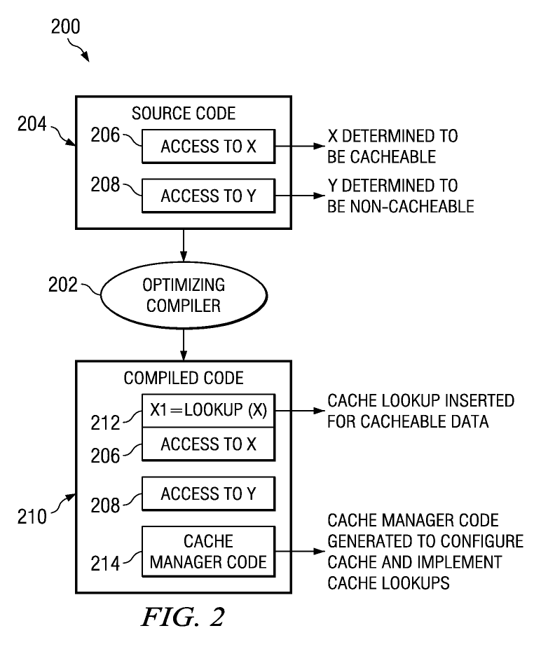

FIG. 2 depicts the exemplary operation of a compiler that may be used to compile data used by an application in accordance with an illustrative embodiment. A compiler is a computer program that translates a series of statements written for one application program in one computer language, commonly called source code, into a resulting output in another computer language, commonly called the object or target language.

In exemplary compiling operation 200, optimizing compiler 202 performs analysis of source code 204 for all references to data that are contained in the code. This analysis includes alias analysis, data dependence analysis, and analysis of the properties of cacheable data, which is illustrated in FIG. 4. Alias analysis determines whether any pair of data references in the program may or must refer to the same memory location. Data dependence analysis determines pairs of data references in the program where one reference uses the contents of a memory location that are written by the other references, or one reference over-writes the contents of a memory location that are used or written by the other reference. Data reference analysis uses the results of alias analysis and data dependence analysis. Within source code 204 there is a data reference to data x 206 and a data reference to data y 208. Optimizing compiler 202 determines as non-cacheable all references to data that are contained in the local memory of the function whose source code 204 is being analyzed. This includes data that is declared as local variables of this function, the parameters to this function, and any other data explicitly marked by the application programmer or another compiler transformation to be non-cacheable. In the example in FIG. 2, optimizing compiler 202 is able to determine that data x 206 is cacheable; however, data y 208 is determined to be non-cacheable.

Optimizing compiler 202 then performs a data reference analysis, which is an analysis to determine certain properties associated with the cacheable data. These properties include, but are not limited to, whether the data is read, written, or both read and written, how often and how far apart a data item is referenced again, whether multiple threads of execution may share the data, the size of a data item, the alignment of the address at which a data item is located, the affinity with which a group of data items are referenced together, and the number of data references active at the same time within a code region.

Once a determination is made as to what data is cacheable or non-cacheable, optimizing compiler 202 is able to generate compiled code 210. In compiled code 210, optimizing compiler 202 inserts modified cache lookup code 212 for cacheable data x 206, based on the software cache configuration to be used. Modified cache lookup code 212 is code that uses memory address bits as keys and provides a mapping from a memory address to the cache line that has the data corresponding to that address, when this data is contained in the cache. Typically, the cache is divided into a number of lines, and depending on what the total cache size and the line size is, a certain number of bits chosen from the address bits define a number that is used as an index into the cache. This index serves as a key that uniquely identifies the cache line(s) that correspond to that address. Additionally, optimizing compiler 202 links cache manager code 214 to compiled code 210 in order to configure the cache and implement modified cache lookup code 212. Cache manager code 214 is separate code that interfaces with modified cache lookup code 212. That is, the modified cache lookup code 212 provides an entry-point into cache manager code 214 when an application executes. Cache manager code 214 is responsible for, among other things, deciding what policy to use when deciding where to place newly fetched data, what data to replace when no space is available, and whether to perform data pre-fetching.

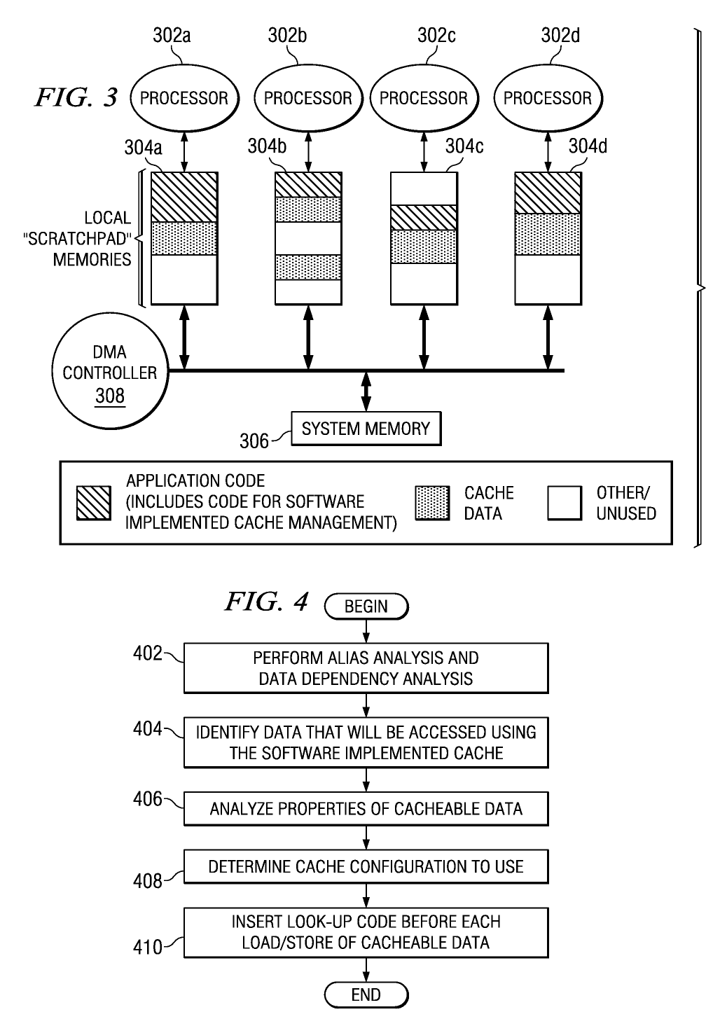

FIG. 3 depicts an exemplary functional block diagram of the components in which the illustrative embodiments may be implemented. Processors 302a, 302b, 302c, and 302d each have associated local memory areas 304a, 304b, 304c, and 304d, respectively, which may be referred to as local “scratchpad” memory. Processors 302a, 302b, 302c, and 302d may be a processor such as synergistic processor unit 103, 104, 105, or 106 of FIG. 1. Local memory areas 304a, 304b, 304c, and 304d may be a cache such as found in local storage area 112, 113, 114, or 115 of FIG. 1.

Each of local memory areas 304a, 304b, 304c, or 304d are comprised of content, such as, application code, cache data, other storage data and may include unused space. Each of local memory areas 304a, 304b, 304c, or 304d are also connected to system memory 306 using direct memory access (DMA) controller 308. System memory 306 may be a memory such as memory 150 of FIG. 1. DMA controller 308 is a system control that can control the memory system without using a central processing unit. On a specified stimulus, DMA controller 308 will move data to/from local memory areas 304a, 304b, 304c, and 304d from/to system memory 306.

In this illustrative embodiment, local memory areas 304a, 304b, 304c, and 304d contain a software implemented cache and usage of memory space may be optimized by optimizing compiler, such as optimizing compiler 202 of FIG. 2. In the illustrative embodiment, the optimizing compiler considers all properties of the cacheable data in the application program that will be stored in cache in each of local memory areas 304a, 304b, 304c, and 304d, including results of alias analysis, data dependence analysis, and data reference analysis. Based on these analyses, the optimizing compiler will determine a set of parameters that will describe a close to optimal software cache configuration for each of local memory areas 304a, 304b, 304c, and 304d. The re-configurable parameters of the cache configuration include total cache size, cache line size, number of lines, associativity of the cache, replacement policy, and method used to determine where in the cache a particular data item should be placed when it is brought in. Cache line size is the amount of data contained in each cache entry, and this may correspond to data at multiple consecutive main memory addresses. Number of lines is the number of entries in the cache. For a datum in main memory that is to be cached, it will be mapped to a cache line based on its memory address. Associativity of the cache is the number of cache lines that are potential candidates for a memory address to map to.

Software implemented cache configuration may be determined by the choice of values for the total cache size, cache line size, number of lines, associativity parameters, replacement policy, and a method used to determine where in the cache a particular data item should be placed when it is brought in. Cache line size decides the basic unit of data that is transferred between the software cache and system memory each time that the cache has to bring in data or write back data. This affects factors such as bandwidth usage, spatial locality, and false sharing. Bandwidth refers to the capacity of the bus used to transfer data to or from the cache, and larger cache lines may unnecessarily use up more bandwidth. Spatial locality is when the application code accesses data at consecutive memory addresses in succession. Since larger cache lines result in the transfer of more consecutive data at a time, they are likely to benefit applications with spatial locality.

False sharing is when data at the same address is included in a cache line in the cache of more than one processing unit, but is actually accessed by code executing on only one of the processing units. False sharing occurs due to the fact that a single large cache line contains data located at multiple consecutive memory addresses. False sharing may lead to overhead associated with keeping the multiple cached copies of the same data coherent.

Cache line size and number of lines together determine the total size of the software implemented cache. Since the optimizing compiler aims to make optimal use of limited local memory available in the system, it will judiciously choose values for these parameters so that the software implemented cache size is balanced with the memory space requirements of other code and data used in an execution of the application.

A higher associativity factor provides more flexibility with regard to choosing a cache line to hold data corresponding to a particular memory address. Higher associativity may promote better use of the memory space occupied by the cache by reducing the number of cache conflicts, that is by reducing the number of times that two different memory addresses map to the same cache line such that only one or the other can be contained in the cache at a given time. However, higher associativity also entails more overhead in the cache lookup code, so the optimizing compiler will choose an associativity factor that accounts for both the cache lookup overhead as well as data reference patterns in the code that may contribute to cache conflicts that have a detrimental effect on application performance.

The parameters of line size, number of lines, and associativity will also influence the cache lookup code modified and/or inserted by the optimizing compiler in the application program since the number of address bits used in the key will be variable for different points in the lookup. Cache lookup code is code that uses memory address bits as keys and provides a mapping from a memory address to the cache line that has the data corresponding to that address, when this data is contained in the cache. Cache lookup code depends on the cache configuration that will be used by the application in configuring the software cache that will be used during the operation of the application.

Positions of the address bits that are used to form the key(s) for cache lookup code may be arbitrarily chosen by the optimizing compiler in order to optimize the compiled code in conjunction with other software analyses, such as data placement. The software implemented cache configuration may also include a replacement policy, a write-back policy, and/or a pre-fetch policy. A replacement policy determines which data item to kick out of the cache in order to free up a cache line in case of conflicts. A write-back policy determines when to reflect changes to cached data back to system memory, and whether to use read-modify-write when writing back a cache line. A pre-fetch policy makes use of a compiler-defined rule to anticipate future data references and transfer corresponding data to cache ahead-of-time.

The cache configuration determined by the optimizing compiler is not required to be used for the entire execution of an application. Rather, the cache configuration may be re-configured dynamically depending on application characteristics and requirements. Additionally, the data may be divided into different data classes based on reference characteristics. Multiple cache configurations may be defined and associated with different data classes.

FIG. 4 depicts an exemplary flowchart of the operations performed by an optimizing compiler in accordance with an illustrative embodiment. As the operation begins, optimizing compiler, which may be an optimizing compiler such as optimizing compiler 202 of FIG. 2, performs alias analysis and data dependency analysis of the code of an application that is being compiled (step 402). Alias analysis determines whether any pair of data references in the program may or must refer to the same memory location. Data dependence analysis determines pairs of data references in the program where one reference uses the contents of a memory location that are written by the other references, or one reference over-writes the contents of a memory location that are used or written by the other reference. The results of alias analysis and data dependence analysis are used to compile a data reference analysis. The optimizing compiler identifies which data will be accessed using the software implemented cache (step 404). The optimizing compiler uses the data reference analysis to analyze the properties of the identified cacheable data (step 406). The optimizing compiler then determines a cache configuration that will be used during application operation (step 408). The determination is based on the results of the data reference analysis. Finally, the optimizing compiler inserts modified lookup code within the software code before each load/store of the cacheable data in the compiled code (step 410), with the operation ending thereafter. The lookup code depends on the configuration of the cache that will be used by the application in configuring the software implemented cache that will be used during the operation of the application.

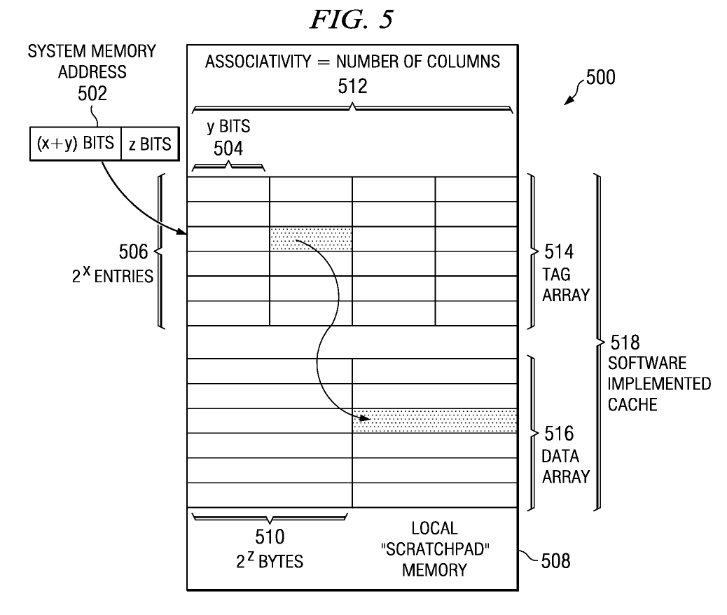

FIG. 5 depicts exemplary cache configuration in accordance with an illustrative embodiment. In cache configuration 500, x, y, and z represent a number of bits in system memory address 502. x, y, z may be varied as long as x+y+z equal the number of bits in system memory address. For example, varying x, as shown by 2^{x} entries 506, controls the size of the cache used, and allows the compiler to balance the use of limited local “scratchpad” memory 508. As another example, varying z, as shown by 2^{z} bytes 510, controls the cache line size. The compiler may use longer cache lines for application data with more spatial locality and shorter cache lines for application data that is likely to suffer from false sharing. Varying associativity 512, which is the number of columns, allows the compiler to optimize likelihood of cache conflicts with respect to available local memory space.

In this illustrative embodiment, there is flexibility to choose which particular x bits in the system memory address determine the index into tag array 514. Tag array 514 consists of 2^{x} entries 506 and y bits 504. The compiler may use this, in conjunction with data placement, to minimize cache conflicts for data that is accessed together, as shown in data array 516. Depending on data reference patterns and re-use characteristics, the replacement policy may be varied from the default least recently used (LRU) policy. Software implemented cache 518 may be dynamically re-configured specific to different phases of a single execution, tailored to the requirements of that phase. Application data may be classified based on its re-use/sharing/read-write properties, and multiple co-existent cache configurations may be used, one for each data class.

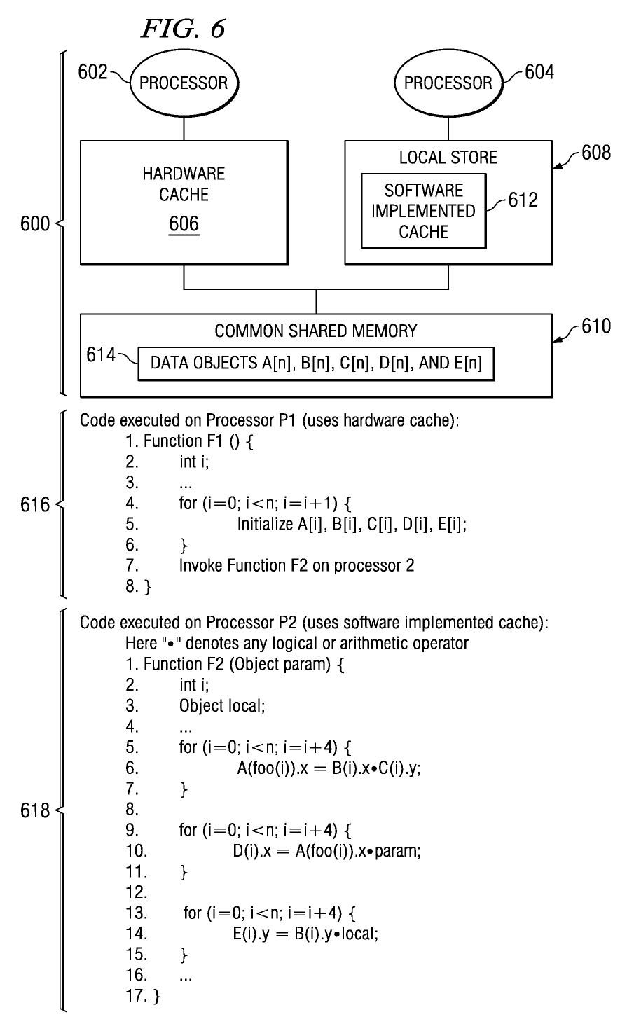

FIG. 6 illustrates the use of a configurable software implemented cache within a data processing system in accordance with an illustrative embodiment. Exemplary data processing system 600 is comprised of processor 602, processor 604, hardware cache 606, local store 608, and common shared memory 610. A portion of local store 608 is managed as software implemented cache 612. Data 614 within common shared memory 610 contains objects A[n], B[n], C[n], D[n], and E[n]. FIG. 6 also depicts software code 616, which is executed on processor 602 and only uses hardware cache 606, and software code 618, which is executed on processor 604 and uses local store 608.

References to objects A, B, C, D, and E in software code 618 are marked as cacheable as those objects are in common shared memory 610 and have to be fetched into processor's 604 software implemented cache 612 before use. When compiling software code 618, a compiler inserts modified lookup code to access this data via software implemented cache 612. References to objects “param”, “i”, and “local” in software code 618 are not marked as cacheable, as these objects are allocated on the local stack frame of software code 618 when it is executed on processor 604, and they do not exist in common shared memory 610.

The compiler analyzes references to objects A, B, C, D, and E in software code 618 to determine how best to cache them in software implemented cache 612. As an illustrative example, although not an exhaustive listing of the kind of information gathered by the data reference analysis, the analysis may determine:
a. B is referenced on lines 6 and 14 of software code 618, but the reference to C on line 6 is not re-used. In case of space constraints in local store 608 after execution of the first loop, it is preferable to retain B in software implemented cache 612 in lieu of C.
b. When the i^{th} element of B, C, D, or E is referenced, the next element to be referenced will be the (i+4)^{th} element. This information can be parameterized and the lookup code can automatically fetch the next element, without waiting for the actual reference to occur. Transferring this information to the software implemented cache management allows it to dynamically determine when to start fetching the data corresponding to subsequent references into software implemented cache 612. Note that this optimization may not be possible for references to A (depending on the effect of function “foo” that returns the index of the element of A to be referenced). Thus, A may be designated to be in a data class separate from B, C, D, and E, and software implemented cache 612 may manage data in the two classes using different policies.
c. The size of each element of A, B, C, D, and E, and the offset between fields “x” and “y” of an element. This information, combined with the loop stride information, can be used to determine an optimal cache line size for this code region.

The data reference analysis results are used to determine the best cache configuration to use, including the total cache size, cache line size, number of lines, associativity, and default policies for placement and replacement of data in software implemented cache 612.

The lookup code for the cacheable references is modified in the compiler to carry the results of the data reference analysis. The modified lookup code is inserted into the compiled software code. The information in the modified lookup code is subsequently used at runtime to efficiently manage and/or configure software implemented cache 612. It is also possible to dynamically update the lookup code based on characteristics observed during execution.

Software code 618 represents exemplary code that is input to a compiler. Lookup code inserted by the compiler typically performs a function similar to a lookup in a hardware cache. In terms of FIG. 5, lookup code uses “x” bits of the system memory address to index into the software implemented cache directory, lookup code compares “y” bits of the system memory address with “y” bits of the tags contained in each column of the row that is indexed into, and looks for a match. If a match is found, the directory entry gives the local store address where the corresponding data is cached, and this local store address is directly used to perform the data reference. If no match is found, then a special function is invoked to handle the cache miss.

This basic functionality remains the same for the lookup code in the re-configurable cache. However, the number and position of the “x” and “y” bits may change. Additionally, a change may occur where a function is invoked to handle a cache miss, then the function may be passed information relating to the properties of the data reference that were earlier analyzed in the compiler.

Thus, the illustrative embodiments provide a compiler optimized software implemented cache that minimizes cache overhead for data accesses. The optimizing compiler may dynamically re-configure the cache specific to different phases of a single execution and tailored to the requirements of that phase. The optimizing compiler may classify application data based on access properties, such as how often and how far apart the data is re-used, whether the data is being read, written, or both read and written, and whether the data is being shared across multiple threads of computation. This classification of data will result in the formation of one or more data classes. The optimizing compiler may use multiple co-existent cache configurations, one for each data class.

The illustrative embodiments can take the form of an entirely hardware embodiment, an entirely software embodiment or an embodiment containing both hardware and software elements. In an illustrative embodiment, implementation is in software, which includes but is not limited to firmware, resident software, microcode, etc.

Furthermore, the illustrative embodiments can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the different embodiments have been presented for purposes of illustration and description, and is not intended to be exhaustive or limited to the illustrative embodiments in the form disclosed. Many modifications and variations will be apparent to those of ordinary skill in the art. The embodiment was chosen and described in order to best explain the principles of the illustrative embodiments, the practical application, and to enable others of ordinary skill in the art to understand the illustrative embodiments for various embodiments with various modifications as are suited to the particular use contemplated.

What is claimed is:

1. A computer implemented method for configuring a cache, comprising:
analyzing software code to identify cacheable information in the software code that will be accessed in the cache at runtime;
analyzing properties of the cacheable information to form a data reference analysis;
determining, based on the data reference analysis, a cache configuration for caching the cacheable information during execution of the software code;
modifying lookup code based on the cache configuration; and
inserting the modified lookup code into the software code, wherein the modified lookup code, when executed, configures the cache.

2. The computer implemented method of claim 1, wherein the software code is associated with an application that is being compiled.

3. The computer implemented method of claim 1, wherein the cache is software implemented cache.

4. The computer implemented method of claim 1, wherein the modified lookup code is inserted before each load/store of the cacheable data in the software code.

5. The computer implemented method of claim 1, wherein the modified lookup code is inserted during compiling of the software code.

6. The computer implemented method of claim 1, wherein the cache configuration includes at least one of line size, number of lines, or associativity of the cache.

7. The computer implemented method of claim 1, wherein positions of address bits that are used to form keys for the modified lookup code are arbitrarily chosen in order to optimize the software code.

8. The computer implemented method of claim 1, wherein the cache configuration also includes one of a replacement policy, a write-back policy, or a pre-fetch policy.

9. The computer implemented method of claim 1, wherein the cache configuration is re-configured dynamically depending on application characteristics and requirements.

10. The computer implemented method of claim 1, wherein the cache configuration is divided into different data classes based on reference characteristics.

11. The computer implemented method of claim 10, wherein multiple cache configurations are defined and wherein the multiple cache configurations are associated with the different data classes.

12. A data processing system comprising:
a bus system;
a communications system connected to the bus system;
a memory connected to the bus system, wherein the memory includes a set of instructions; and
a processing unit connected to the bus system, wherein the processing unit executes the set of instructions to perform an analysis of software code to identify cacheable information in the software code that will be accessed in the cache at runtime; analyze properties of the cacheable information to form a data reference analysis; determine, based on the data reference analysis, a cache configuration for caching the cacheable information during execution of the software code; modify lookup code based on the cache configuration; and insert the modified lookup code into the software code, wherein the modified lookup code, when executed, configures the cache.

13. The data processing system of claim 12, wherein the software code is associated with an application that is being compiled.

14. The data processing system of claim 12, wherein the cache is software implemented cache.

15. The data processing system of claim 12, wherein the cache configuration includes at least one of line size, number of lines, or associativity of the cache.

16. A computer program product comprising:
a computer usable medium including computer usable program code for configuring a cache, the computer program product including:
computer usable program code for performing an analysis of software code to identify cacheable information in the software code that will be accessed in the cache at runtime;
computer usable program code for analyzing properties of the cacheable information to form a data reference analysis;
computer usable program code for determining, based on the data reference analysis, a cache configuration for caching the cacheable information during execution of the software code;
computer usable program code for modifying lookup code based on the cache configuration; and
computer usable program code for inserting the modified lookup code into the software code, wherein the modified lookup code, when executed, configures the cache.

17. The computer program product of claim 16, wherein the software code is associated with an application that is being compiled.

18. The computer program product of claim 16, wherein the cache is software implemented cache.

19. The computer program product of claim 16, wherein the cache configuration includes at least one of line size, number of lines, or associativity of the cache.

20. The computer program product of claim 16, wherein the cache configuration is re-configured dynamically depending on application characteristics and requirements.
